(19) United States
(12) Patent Application Publication
(10) Pub. No.: US 2015/0076056 A1
(43) Pub. Date: Mar. 19, 2015

(54) DEVICE FOR USE IN FLUID PURIFICATION

(71) Applicant: University of The Witwatersrand, Johannesburg, Johannesburg (ZA)

(72) Inventors: Sunny Esayegbemu Iyuke, Johannesburg (ZA); Selby Maphutha, Vanderbijlpark (ZA)

(21) Appl. No.: 14/490,396

(22) Filed: Sep. 18, 2014

(30) Foreign Application Priority Data
Sep. 18, 2013 (ZA) 2013/07039

(51) Int. Cl. B01D 71/68; B01D 71/02; B01D 67/00; B01D 71/38

(52) U.S. Cl. CPC B01D 71/68; B01D 71/38; B01D 71/021; B01D 67/0079; B01D 67/0002; B01D 67/0013; B01D 67/0011
USPC 210/500.41; 210/500.27; 210/500.42; 264/129

(57) ABSTRACT

The present disclosure relates to a device for use in fluid purification, particularly to a membrane for use in fluid purification, the membrane comprising a porous basal layer in the form of polysulfone (PSF); a multitude of multi-walled carbon nanotubes (CNTs) dispersed within the basal layer; and a top layer in the form of polyvinyl alcohol (PVA). The disclosure extends to a method of manufacturing the device.

### FIELD OF INVENTION

The present disclosure relates to a device for use in fluid purification, particularly to a polymeric device for use in water purification. Most particularly, the disclosure relates to a device having a carbon nanotube (CNT) containing polysulfone (PSF) layer and a polyvinyl alcohol coating over at least a portion of the PSF layer for use in separating oil from water in the treatment of oil-containing waste water. The disclosure extends to a method of manufacturing the device.

### BACKGROUND

High volumes of wastewater in the form of oil-water emulsions are produced in various industries such as oil fields, petrochemical, metallurgical, pharmaceutical and others¹. Oil concentrations in wastewater generated in the above industries² range from 50-1000 mg/L however, the acceptable discharge limit³ is only 10-15 mg/L. Water purification devices, and especially membrane water filtration devices are well known and often utilized in industry in order to purify water. Often membrane water filtration devices are categorized based on the minimum size of suspended particles they can separate out from waste water streams, namely microfiltration (0.1-10 μm), ultrafiltration (0.01-0.10 μm), nanofiltration (order of nanometers). Other filtration devices are categorized based on the type of particle it can separate out from waste water streams, such as reverse osmosis which can remove mono-ionic salts in solution from a waste water stream. Microfiltration⁴, ultrafiltration⁵, nanofiltration and reverse osmosis⁶ have all been successfully used in the separation of oil from water. These techniques are useful because of the high quality of purified water produced, simpler module design, low amount of chemicals used and low energy consumption compared to other known treatment techniques⁷. Although the aforementioned techniques are attractive, they are not without problems.

The two major problems with membrane filtration devices are fouling and concentration polarization. Fouling is the accumulation of substances on the surface and/or inside the membrane or its pores, thereby decreasing the filtration ability and/or performance of the membrane⁸⁻¹⁰. Membrane fouling may occur due to the following reasons¹¹: (i) biological fouling, which is the growth of biological species on the membrane surface, (ii) colloidal fouling, which leads to a loss of permeate flux through the membrane, (iii) organic fouling, which is the deposition of organic substances on or inside the membrane, and (iv) scaling, which is the formation of mineral deposits precipitating from the waste water stream onto the membrane surface. Controlling fouling is ideal in order to reduce the need for cleaning and to enhance the permeate yield.^{12,13} When a waste water stream is in contact with the membrane, the individual components in the waste water stream permeate at different rates. Concentration polarization is when the components that permeate slowly, or not at all, accumulate and create a layer near the membrane surface.

There exists a need for novel water purification devices that at least ameliorate one of the abovementioned problems.

### DEFINITIONS

The following terms contained in this patent specification are defined as follows:
“carbon nanostructures” are particles being allotropes of carbon having a bonding structure of sp² hybridized orbitals, wherein each particle or wherein a cluster of particles has at least a minor dimension in the submicron range.
“carbon nanotube” a type of carbon nanostructure typically a fullerene-like structure and is also known as a buckytube and includes single-walled carbon nanotubes, multi-walled carbon nanotubes, torus shaped carbon nanotubes, nanobuds and cup stacked carbon nanotubes. Typically carbon nanotubes are elongate and substantially cylindrical. Typically a carbon nanotube has a size in a minor dimension in a range between about 0.1 to about 100 nanometers, and a size in a major dimension in a range between about 1 to about 1000 nanometers, and any value in between the aforementioned ranges.

### SUMMARY

In accordance with a first aspect of this disclosure there is provided a device for use in fluid purification, the device comprising:
a hydrophobic polymer layer;
a multitude of carbon nanostructures dispersed within the hydrophobic polymer layer; and
a hydrophilic substance at least partially coating the hydrophobic layer.

The device may be a membrane.

The hydrophilic layer may further comprise a cross-linker substance. The cross-linker substance may comprise at least one substance selected from the group consisting of, but not limited to: period acids, metal salts, any one of the Hofmeister series of salts, aldehydes, dialdehydes, hydrogen together with hydroxyl radicals, and carboxylic acids. In a preferred embodiment of the invention the cross-linker is a carboxylic acid, preferably a dicarboxylic acid, most preferably maleic acid.

The cross-linker substance in use may facilitate improving the stability of the hydrophilic layer.

The hydrophobic layer may be porous.

The hydrophobic polymer layer may comprise at least one compound selected from the group consisting of, but not limited to: natural or synthetic hydrophobic polymers. In a preferred embodiment of the first aspect of this disclosure the hydrophobic polymer may be polysulfone.

The carbon nanostructure may be at least one of the group consisting of, but not limited to: a carbon nanotube, a carbon nanofibre, a helical carbon nanotube, and a carbon nanoball. Preferably, the carbon nanostructure is a multi-walled carbon nanotube.

The carbon nanostructure located within the hydrophobic layer may in use enhance the hydrophobic properties of the hydrophobic layer and/or increase the porosity of the hydrophobic layer and/or increases the strength of the hydrophobic layer.

In a preferred embodiment of the disclosure the hydrophobic polymer layer comprises between about 0.1 to about 7.5% of carbon nanostructures, which carbon nanostructures are dispersed within the hydrophobic polymer layer.

The hydrophilic substance may be a polymer and hydrophilic polymers may contain polar and/or charged functional groups. The hydrophilic substance may comprise at least one compound selected from the group consisting of, but not limited to: natural or synthetic hydrophilic polymers. In a preferred embodiment of the first aspect of this disclosure the hydrophilic polymer is polyvinyl alcohol (PVA).

The device, preferably a membrane, may be layered such that the hydrophobic polymer layer is a basal layer and has on top of an upper surface thereof a top layer comprising the hydrophilic substance. The membrane may be configured as a layered sandwich having the top layer superposingly located over the basal layer.

In an alternative embodiment of the first aspect of this disclosure, there is provided for the device, preferably a membrane, to be layered such that the hydrophobic layer is an inner core and has coated there over an outer shell comprising the hydrophilic substance. The membrane may be configured as a layered onion having the inner core coated by the outer shell.

In a preferred embodiment of the first aspect of this disclosure, there is provided a membrane for use in fluid purification, the membrane comprising:
a porous basal layer in the form of polysulfone (PSF);
a multitude of carbon nanotubes (CNTs) dispersed within the basal layer; and
a top layer in the form of polyvinyl alcohol (PVA).

In the preferred embodiment of the first aspect of the disclosure, the top layer of polyvinyl alcohol (PVA) may further comprise a cross-linker substance in the form of maleic acid (MA) in use cross-linking the polyvinyl alcohol (PVA).

According to a second aspect of this disclosure, there is provided a method for manufacturing the device for use in fluid purification according the first aspect of this disclosure, the method comprising the following steps:
(a) adding a hydrophobic polymer, preferably polysulfone (PSF), and carbon nanostructures, preferably multi-walled carbon nanotubes, to an organic solvent, preferably dimethylformamide (DMF), under constant stirring to produce Solution 1;
(b) casting Solution 1 onto a surface and allowing the cast Solution 1 to stand for a first period of time;
(c) immersing the cast Solution 1 in water for a second period of time to form a solid porous basal layer;
(d) pouring a hydrophilic substance, preferably polyvinyl alcohol (PVA), over the porous basal layer to form a bilayered membrane; and
(e) placing the bilayered membrane into a heated oven for a third period of time.

The method may comprise an additional step, Step (f) prior to executing Step (e), Step (f) comprising pouring a cross-linker substance, preferably a maleic acid solution, over the hydrophilic substance, preferably polyvinyl alcohol (PVA), to facilitate cross-linking of the hydrophilic substance.

In a preferred embodiment of the second aspect of this disclosure, there is provided a method for manufacturing the membrane for use in fluid purification according to the first aspect of this disclosure, the method comprising the following steps:
(a) adding polysulfone (PSF) and multi-walled carbon nanotubes to dimethylformamide (DMF) under constant stirring to produce Solution 1;
(b) casting Solution 1 onto a surface and allowing the cast Solution to stand for a first period of time;
(c) immersing the cast Solution in water for a second period of time to form a solid porous basal polysulfone (PSF)-carbon nanotube (CNT) layer;
(d) pouring polyvinyl alcohol (PVA) solution over the polysulfone (PSF)-carbon nanotube (CNT) layer to form a bilayered membrane; and
(e) placing the bilayered membrane into a heated oven for a third period of time.

The method may comprise an additional step, Step (f) prior to Step (e), Step (f) comprising pouring a maleic acid solution over the polyvinyl alcohol (PVA) to facilitate cross-linking of the polyvinyl alcohol (PVA).

According to a third aspect of this disclosure there is provided for use of the device as described in the first aspect of this disclosure in the purification of a water sample, the water sample comprising at least water and oil, such that in use, water flows through the device and oil is hindered from flowing through the device. There is provided for a device substantially as herein described, illustrated and/or exemplified with reference to the detailed description and/or any one of the figures.

There is provided for a method for manufacturing a device, the method as substantially as herein described, illustrated and/or exemplified with reference to the detailed description and/or any one of the figures.

There is provided for use of a device substantially as herein described, illustrated and/or exemplified with reference to the detailed description and/or any one of the figures.

### BRIEF DESCRIPTION OF THE DRAWINGS

The disclosure is now described by way of example only, with reference to the accompanying diagrammatic drawings, in which:

FIG. 1 shows a SEM image of a polysulfone (PSF) layer of the membrane (a) low and (b) high magnification without CNTs. BET analysis gives the average adsorption pore size as 18.9 nm;

FIG. 2 shows a PSF layer of the membrane with 5% CNT (w/w) loading (a) low and (b) high magnification, PSF layers with 10% CNT (w/w) loading (c) low and (d) high magnification. BET analysis gives the average adsorption pore size of 27.6 nm for 5% CNT loading and 31.8 nm for 10% CNT loading;

FIG. 3 shows a SEM image of the polyvinyl alcohol (PVA) thin layer on basal (PSF) layer (a) low and (b) high magnification. No visible pores are seen due to the top layer of PVA being present;

FIG. 4 shows plots of (a) Young's modulus (MPa), (b) Toughness (J/cm³), (c) Ultimate tensile strength (MPa) and (d) Yield Stress (MPa) as a function of CNT loading in PSF. At a concentration of 7.5% CNTs in the polymer composite, there is a 119% increase in the ultimate tensile strength, 77% increase in the Young's modulus, 258% increase in the toughness and a 79% increase in the yield strength. These increases are relative to 0% CNT loading;

FIG. 5 shows the permeate concentration for different % CNT loading. There is an increase in permeate concentration with an increase in pressure and % CNT loading. After 5 bar, the permeate concentration exceeds the lower limit of the allowable discharge concentration which is 10 mg/L; and

FIG. 6 shows the flux through the membrane at different pressures and % CNT loading. The increase in flux is due to the increase in % CNT loading which alters the CNT-PSF layer structure as can be seen in FIGS. 1 and 2.

### DETAILED DESCRIPTION OF THE DRAWINGS

In accordance with a first aspect of this disclosure there is provided a device for use in fluid purification, typically water purification, the device comprising a hydrophobic polymer layer; a multitude of carbon nanostructures dispersed within the hydrophobic polymer layer; and a hydrophilic substance at least partially coating the hydrophobic layer. Typically, the device is a membrane.

In a preferred embodiment of the disclosure the hydrophobic polymer layer comprises between about 0.1 to about 7.5% of carbon nanostructures, which carbon nanostructures are dispersed within the hydrophobic polymer layer.

The hydrophilic layer typically further comprises a cross-linker substance. The cross-linker substance may comprise at least one substance selected from the group consisting of, but not limited to: period acids, metal salts, any one of the Hofmeister series of salts, aldehydes, dialdehydes, hydrogen together with hydroxyl radicals and carboxylic acids. In a preferred embodiment of the invention the cross-linker substance is a carboxylic acid, preferably a dicarboxylic acid, most preferably maleic acid. The cross-linker substance in use may facilitate improving the stability of the hydrophilic layer.

The hydrophobic layer is typically porous in nature. The hydrophobic polymer layer may comprise at least one compound selected from the group consisting of, but not limited to: natural or synthetic hydrophobic polymers. In a preferred embodiment of the first aspect of this disclosure the hydrophobic polymer may be polysulfone. Polysulfone is porous by nature. Typically the hydrophobic layer is membranous.

The carbon nanostructure may be at least one of the group consisting of, but not limited to: a carbon nanotube, a carbon nanofibre, a helical carbon nanotube, and a carbon nanoball. Preferably, the carbon nanostructure is a multi-walled carbon nanotube. The carbon nanotube located and dispersed within the hydrophobic layer in use enhances the hydrophobic properties of the hydrophobic layer and/or increases the porosity of the hydrophobic layer and/or increases the strength of the hydrophobic layer.

The hydrophilic substance may be a polymer and hydrophilic polymers may contain polar and/or charged functional groups. The hydrophilic substance may comprise at least one compound selected from the group consisting of, but not limited to: natural or synthetic hydrophilic polymers. In a preferred embodiment of the first aspect of this disclosure the hydrophilic polymer is polyvinyl alcohol (PVA).

The membrane may be layered such that the hydrophobic polymer layer is a basal layer and has on top of an upper surface thereof a top layer comprising the hydrophilic substance. The membrane may be configured as a layered sandwich having the top layer superposingly located over the basal layer.

In an alternative embodiment of the first aspect of this disclosure, there is provided for the membrane to be layered such that the hydrophobic layer is an inner core and has coated there over an outer shell comprising the hydrophilic substance. The membrane may be configured as a layered onion having the inner core coated by the outer shell.

In a preferred embodiment of the first aspect of this disclosure, there is provided a membrane for use in fluid purification, the membrane comprising a porous basal layer in the form of polysulfone (PSF); a multitude of carbon nanotubes (CNTs) dispersed within the basal layer; and a top layer in the form of polyvinyl alcohol (PVA). The top layer of polyvinyl alcohol (PVA) may further comprise a cross-linker substance in the form of maleic acid (MA) in use cross-linking the polyvinyl alcohol (PVA).

According to a second aspect of this disclosure, there is provided a method for manufacturing the device for use in fluid purification according to the first aspect of this disclosure, the method comprising the following steps:
(a) adding a hydrophobic polymer, preferably polysulfone (PSF), and carbon nanostructures, preferably multi-walled carbon nanotubes, to an organic solvent, preferably dimethylformamide (DMF), under constant stirring to produce Solution 1;
(b) casting Solution 1 onto a surface and allowing the cast Solution 1 to stand for a first period of time;
(c) immersing the cast Solution 1 in water for a second period of time to form a solid porous basal layer;
(d) pouring a hydrophilic substance, preferably polyvinyl alcohol (PVA), over the porous basal layer to form a bilayered membrane; and
(e) placing the bilayered membrane into a heated oven for a third period of time.

The method may comprise an additional step, Step (f) prior to executing Step (e), Step (f) comprising pouring a cross-linker substance, preferably a maleic acid solution, over the hydrophilic substance, preferably polyvinyl alcohol (PVA), to facilitate cross-linking of the hydrophilic substance.

According to a third aspect of this disclosure there is provided for use of the device as described in the first aspect of this disclosure in the purification of a water sample, the water sample comprising at least water and oil, such that in use, water flows through the device and oil is hindered from flowing through the device.

There is provided for a device substantially as herein described, illustrated and/or exemplified with reference to the detailed description and/or any one of the figures.

There is provided for a method for manufacturing a device, the method as substantially as herein described, illustrated and/or exemplified with reference to the detailed description and/or any one of the figures.

There is provided for use of a device substantially as herein described, illustrated and/or exemplified with reference to the detailed description and/or any one of the figures.

Representative examples of the invention are described, illustrated and/or exemplified in detail hereunder.

Here below, the manufacturing and testing of the device, typically a membrane, according to certain embodiments of the first and second aspect of this disclosure are described in detail. The examples described, illustrated and/or exemplified below demonstrate the effectiveness of the device according to this disclosure in rejecting oil from waste water streams. Carbon nanotubes (CNTs) exhibit many desirable mechanical, thermal and other properties for a variety of applications²⁰. It is also shown hereunder that CNTs forming part of the membrane are able to increase the mechanical strength of the membrane whilst ensuring the highly effective ability of the membrane for oil-water separation.

Methods

A vertically orientated continuous chemical vapor deposition (CVD) reactor was used to produce CNTs at 850° C. as outlined in previous studies^{24,25}, which studies are fully incorporated herein by reference. During the production of the CNTs ferrocene was used and acts as both the catalyst and carbon source for the CNT production. 4 g of ferrocene was placed inside the vaporizer and the vapor was carried to the reactor by argon carrier gas. The solid carbon product of CNTs was collected from a cyclone and characterized using a transmission electron microscope (TEM) (JOEL 100S).

A phase inversion method¹⁷, which method is fully incorporated herein by reference, was used to produce the membranes in accordance with this disclosure. A 10% (w/v) polysulfone (PSF) solution was prepared in dimethylformamide (DMF) under constant stirring. The solution was cast on a glass plate with the aid of a casting blade. The cast solution was left in ambient conditions for 10 seconds and thereafter fully immersed in distilled water for a period of 24 hours. A 1% (w/v) aqueous polyvinyl alcohol (PVA) solution was poured over the PSF layer (which PSF layer acting as a support) and kept in contact for 3 minutes after which the excess PVA solution was drained off to expose a PVA top layer coated over the basal PSF layer. A 1% (w/v) maleic acid (MA) solution, wherein MA acts as the cross-linker substance, was poured on the PVA top layer and kept in contact for 3 minutes (to allow enough time for cross-linking) after which it was drained off. The membrane was then heated in an oven at 125° C. for 15 minutes. The structure of the membranes was characterized using a scanning electron microscope (SEM) (FBI FIB/SEM Nova 600 Nanolab). BET (Brunauer-Emmett-Teller) analysis was conducted using the Tristar 3000 V6.05 A to obtain pore size information.

In order to produce the CNT containing PSF polymer layer, the CNTs were blended with the PSF polymer solution in varying concentrations (from 0-10% w/v) before the solution was cast and immersed in water. The CNTs were dispersed with the aid of ultrasonic agitation in the PSF membrane solution before casting. The mechanical tests on the membranes were carried out on the Hysitron Nanotensile 5000 Tester using thin rectangular (5 mm×30 mm×0.05 mm) samples of the membrane. The Young's modulus, toughness, ultimate tensile strength and yield stress were obtained from the mechanical tests.

The resulting device, a membrane, for fluid purification comprised a porous basal layer in the form of polysulfone (PSF); a multitude of carbon nanotubes (CNTs) dispersed within the basal layer; and a top layer in the form of cross-linked polyvinyl alcohol (PVA).

For demonstration of oil-water separation, a reservoir was filled with distilled water (18 L) and synthetic oil (50 ml). The reservoir was continuously stirred and heated to 35° C. to facilitate mixing. The ensuing simulated waste water stream (the water-oil mixture) was pumped through the membrane in accordance with this disclosure and flow readings were taken using a rotameter. The concentration of oil in the simulated waste water stream (after ultrasonication and continued stirring) was found to be ˜287 mg/L.

In a preferred embodiment of this disclosure, the membrane comprises a CNT containing PSF layer having coated onto an upper surface thereof a cross-linked PVA layer, such that the membrane is layered like a sandwich. It is to be understood that in an alternative embodiment of the invention, the membrane may comprise a CNT containing PSF layer being wholly coated with a PVA layer, such that the membrane is layered like an onion. Such an onion embodiment is not described in detail hereunder.

Results and Discussion

CNTs were synthesised at 850° C. using a previously-described bulk production process^{24,25}, which process is fully incorporated herein by reference, and ranged between 500 nm and 1000 mu in length. The concentric arrangement of graphene sheets parallel to a tube axis, which is typical for a multi-walled tube structure, was confirmed by transmission electron microscopy (TEM) images presented in the applicant's previous publications^{24,25}, which previous papers are fully incorporated herein by reference The diameter distribution of the as-produced CNTs was uniform with diameters less than 100 nm observed. A close analysis of TEM images revealed representative multiwalled-CNTs with inner diameters of 6.2-7.9 nm and outer diameters of 26.2-32.1 nm. As the CNTs were not purified or subjected to acid treatment before utilization, there was no introduction of any functional groups on the surface of the CNTs.

As explained above, the CNTs were added to the PSF solution prior to casting. Once cast a PVA solution was layered over an upper surface of the CNT containing PSF layer so as to form a sandwich layered membrane according to the first aspect of this disclosure.

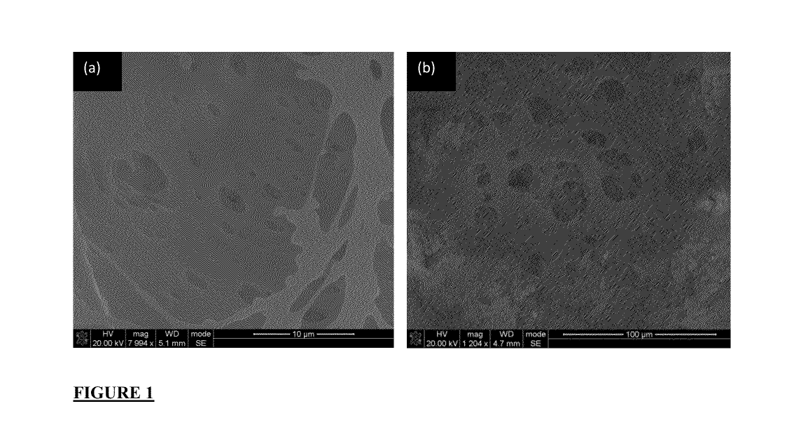

FIGS. 1a and b shows scanning electron microscopy (SEM) images of the bottom a CNT free (Polysulfone, PSF) layer of the membrane. This CNT free PSF layer is highly porous with the visible pores being less than 10 microns. This CNT free PSF layer contains no CNTs for comparison purposes.

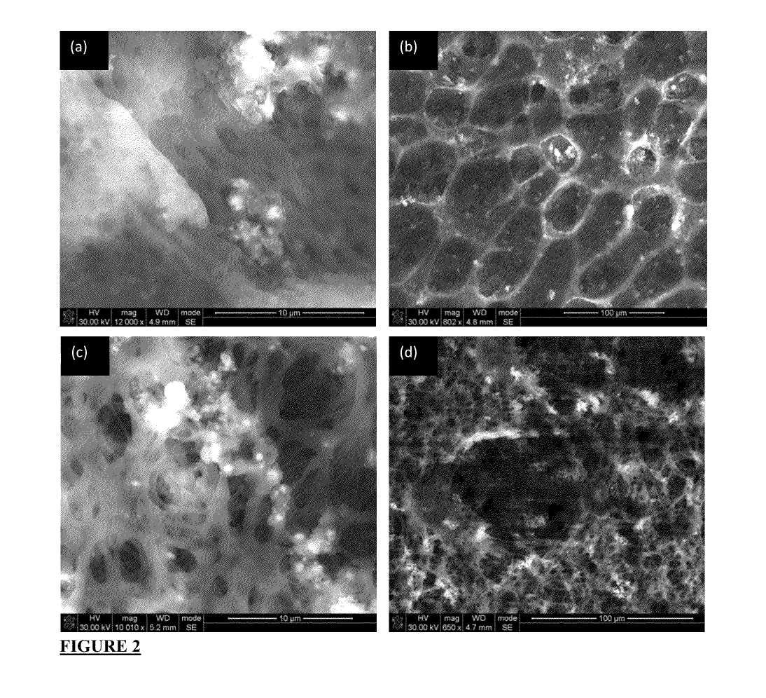

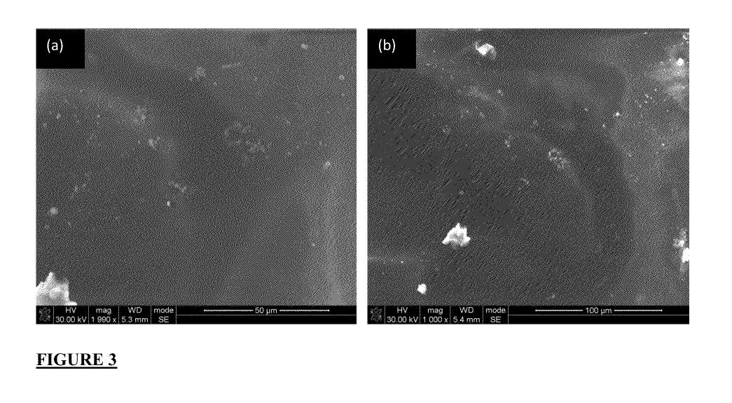

FIG. 2a to d shows the bottom of a CNT containing PSF layer of the membrane with 5% (FIGS. 2a and b) and 10% (FIGS. 2c and d) CNTs in the polymer solution (prior to casting). The structure of this CNT-PSF-layer changes with the addition of CNTs. The pores for the 10% CNT case (FIGS. 2c and d) appear to be more numerous and more finely dispersed than at lower concentrations (FIGS. 2a and b). BET (Brunauer-Emmett-Teller) analysis gives the average adsorption pore width as 18.9 nm at 0% CNT, 27.6 nm at 5% CNT and 31.8 nm at 10%. FIG. 3 shows the PVA layer on top of the bottom (PSF) porous layer indicating no clearly visible pores on the SEM images.

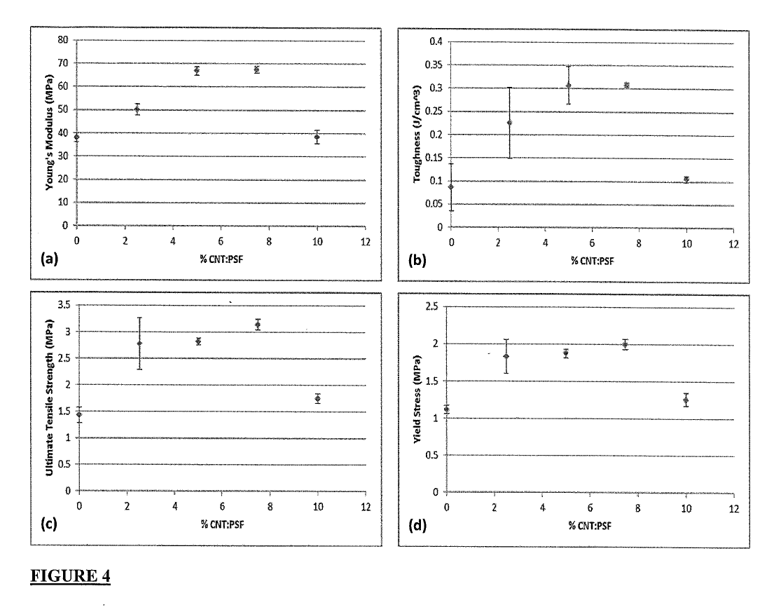

FIG. 4 shows the results from the tensile tests conducted on the fabricated membranes. The Young's modulus and toughness increase with CNT concentration first and then decrease after a threshold concentration (7.5% CNT:PSF) is reached. This drop in mechanical properties is due to the ready re-agglomeration of CNTs creating bundles at higher concentrations. Studies have shown that CNT bundles display diminished mechanical properties compared to a single CNT²⁶. As such, it is important to obtain even distribution of unclustered CNTs across the matrix. The mechanical properties obtained in this study and displayed in FIG. 4 and the corresponding error bars are comparable to results obtained from diverse processing techniques²⁷⁻³⁴ with variables such as degree of dispersion of CNTs, CNT concentrations in the polymer, various polymer matrices etc. as all these parameters affect the mechanical properties. At 7.5% CNT concentration, there is a 119% increase in the ultimate tensile strength, 77% increase in the Young's modulus and 258% increase in the membrane toughness, all relative to 0% CNT concentration in the membrane. These values are quite favorable as there was no modification or purification of the CNTs used in the PSF polymer solution. As-grown CNTs contain amorphous carbon and graphitic particles²⁴ and it is possible to further improve the mechanical properties by using purified CNTs and other surface modification techniques.

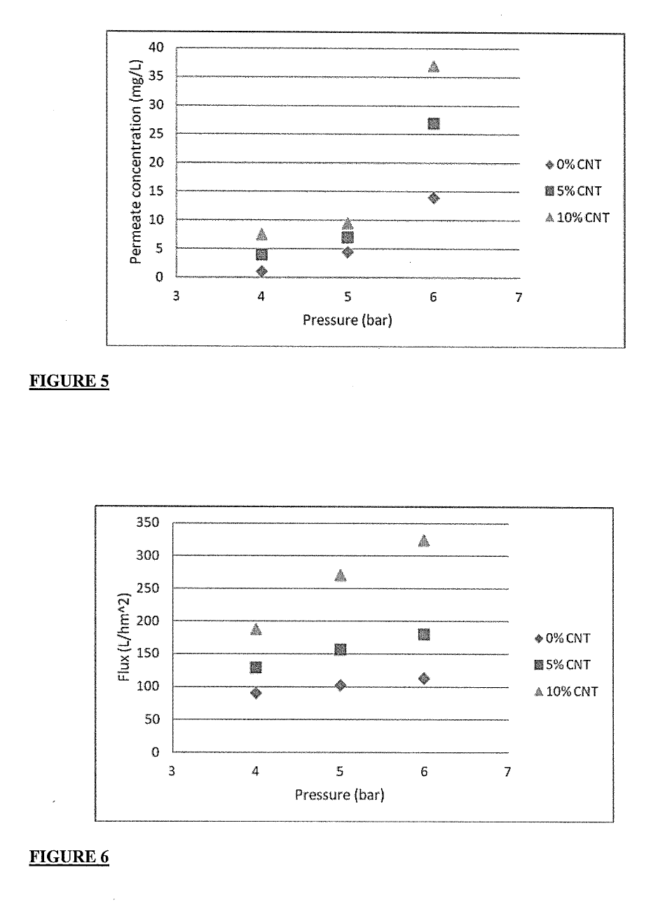

The rejection of oil by the device, typically a membrane, according to the first aspect of this disclosure can be calculated using Equation 1:

$$R ( \% ) = [ 1 - \frac{{C}_{p}}{{C}_{f}} ] \times 100 \qquad ( 1 )$$

where R is the rejection, and C_{f} and Cₚ are the feed and permeate concentrations, respectively. The flux through the membrane is determined using Equation 2,

$$F = \frac{V}{{At}^{′}} \qquad ( 2 )$$

where F is the flux, A is the effective membrane area and V is the volume of permeate through the membrane during time t. The rejection values of the membrane calculated using Equation 1 are given in Table 1 and FIG. 5 shows the permeate concentration values. There is an increase of the oil concentration in the permeate and a decrease in the membrane rejection with an increase in pressure. As the trans-membrane pressure increases, it rises above the capillary pressure of the membrane, which prevents the oil from entering the pores², leading to the oil being forced through the pores. There is also a decrease in the membrane rejection with an increase in the CNT concentration in the membrane. This is expected as the structure of the PSF layer is altered by the pores growing larger, with the addition of CNTs, to form a porous CNT-PSF layer. The structure of the bottom layer in a thin film composite membrane has been shown to have an effect on the flux and the separation efficiency of the membrane¹⁷. Permeate concentrations below 10 mg/L are achieved at 4 and 5 bar pressures by all the membranes as seen in FIG. 5.

FIG. 6 shows the flux calculated using Equation 2 for different % CNT loadings and pressures. The flux through the membrane increases with an increase in pressure and CNT concentration. The flux achieved herein is comparable³⁵ to or higher^{6,36} than previously reported values. Similar to the impact on membrane separation efficiency, the CNTs alter the pore structure of the PSF layer allowing for greater flux across the membrane. The SEM images (FIGS. 1 and 2) indicate an increase in pore diameter with an increase in the CNT concentration. The permeate flux can also be attributed to the PVA layer which is hydrophilic Cross-linking the PVA layer with dicarboxylic acid (maleic acid) has been shown to improve stability of the membrane^{17,39}. The intramolecular crosslinked molecules are smaller in size than the initial polymer molecules with their size being dependent on the degree of crosslinking⁴⁰. The incorporation of CNTs into the membrane used herein show that it is still feasible to have such high flux recovery ratio whilst also increasing membrane mechanical strength. Without being limited to theory, this finding is surprising and unexpected, since the incorporation of CNTs typically decreases mechanical strength by increasing the porosity of the membrane. Finally, though the simulated waste water stream (oil/water mixtures) tested here is artificial and oil-containing waste water is known to have trace amount of surfactants, the results described herein are still meaningful and practical. Chakraborty et al.⁵ suggest that additives in oily waste water from plant operations will have an effect on the membrane performance; however, the oil particle size has a larger effect on the membrane performance relative to that by the additives in the oily waste water.

In summary, a bilayered membrane consisting of a hydrophobic porous CNT-PSF basal layer coated with a hydrophilic polyvinyl alcohol (PVA) layer has been manufactured and tested for the separation of oil from water in waste water streams. At a concentration of 7.5% CNTs, a 119% increase in the ultimate tensile strength, 77% increase in the Young's modulus and 258% increase in the toughness were seen indicating the suitability of the membrane in practical applications. Increasing the trans-membrane pressure decreases the membrane separation but increases the flux. In the same way, increasing the CNT concentration in the membrane decreases rejection but increases membrane flux. The hydrophilic PVA layer of the membrane attracts water and facilitates its passage therethrough, whilst the hydrophobic CNTs in the PSF layer repels contaminated water. What results is purified water on one side of the membrane and contaminants (in this case oil) on the other. The hydrophobic CNTs repel the contaminated water thereby hindering any accumulation of contaminants and thus improving fouling.

Applicant believes that the device according to this disclosure will find application in at least sewage waste water treatment and mine waste water treatment, specifically in the treatment of acid mine drainage. By essentially functioning as a filter the purification by the device expends less energy than typical water purification systems which often require heating and/or cooling is provides for a cost effective alternative to known purification systems. The device is also easy and cheap to manufacture. It is to be understood that the device according to this disclosure is suitable for use in a wide variety of applications that involve the purification of fluid.

While the disclosure has been described in detail with respect to specific embodiments and/or examples thereof, it will be appreciated that those skilled in the art, upon attaining an understanding of the foregoing may readily conceive of alterations to, variations of and equivalents to these embodiments. Accordingly, the scope of the present disclosure should be assessed as that of the claims and any equivalents thereto, which claims appended hereto.

### REFERENCES

The references below are fully incorporated into this provisional patent application by reference.

1. Siriverdin, T. and Dallbauman, L. Organic matrix in produced water from the osage-skiatook petroleum environmental research site. Chemosphere, 57, 463-469 (2004).

2. Chakrabarty, B., Ghoshal, A. K. and Purkait, M. K. Ultrafiltration of stable oil-in-water emulsion by polysulfone membrane. J. Membrane Sci., 325, 427-437 (2008).

3. Bevis, A. The treatment of oily water by coalescing. Filt. Sep., 295-301 (1992).

4. Abadi, S. R., Sebzari, M. R., Rekabdar, M. H. and Mohammadi, T. Ceramic membrane performance in microfiltration of oily wastewater. Desalination, 265, 222-228 (2011).

5. Chakrabarty, B., Ghoshal, A. K. and Purkait, M. K. Cross-flow ultrafiltration of stable oil-in-water emulsion. Chem. Eng. J., 165, 447-456 (2010).

6. Mondal, S. and Wickramasinghe, S. R. Produced water treatment by nanofiltration and reverse osmosis membranes. J. Membrane Sci., 322, 162-170 (2008).

7. Konieczny, K. Modelling of membrane filtration of natural water or potable purposes. Desalination, 143, 123-139 (2002).

8. Lee, K. P., Arnot, T. C., Mattia, D. A review of reverse osmosis membrane materials for desalination—development to date and future potential. J. Membrane Sci., 370, 1-22 (2011).

9. Gekas, V. and Hallstrom, B. Microfiltration membranes, cross-flow transport mechanisms and fouling studies. Desalination, 77, 195-218 (1990).

10. Wakeman, R. J. and Williams, C. J. Additional techniques to improve microfiltration. Sep. Purif Technol., 26, 3-18 (2002).

11. Durancear, S. J. Membrane Practices for Water Treatment. Denver: American Water Works Association (2001).

12. Van der Bruggen, B. and Vandecasteele, C. Distillation vs. membrane filtration: overview of process evolutions in seawater desalination. Desalination, 143, 207-218 (2002).

13. Van der Bruggen, B., Manttari, M., Nystromb, M. Drawbacks of applying nanofiltration and how to avoid them: a review. Sep. Purif. Technol., 63, 251-263 (2008).

14. Al-Amoudi, A. and Lovitt, R. W. Fouling strategies and the cleaning system of NF membranes and factors affecting cleaning efficiency. J. Membrane Sci., 303, 6-28 (2007).

15. Hirai, T., Asada, Y., Suzuki, T., Hayashi, S. Studies on elastic hydrogel membrane. I. effect of preparation conditions on the membrane performance. J. Appl. Polymer Sci. 38, 491-502 (1989).

16. Ibrahim, N. A., Abo-Shosha, M. H. Preparation and characterization of carboxylic cation exchange resins from the reaction of poly(vinyl alcohol) with melamine-formaldehyde and some hydroxy acids. Angewandte Makromolekulare Chemie, 210, 7-20 (1993).

17. Gohil, J. M. and Ray, P. Polyvinyl alcohol as the barrier layer in thin film composite nanofiltration membranes: Preparation, characterization, and performance evaluation. J. Colloid Interface Sci., 338, 121-127 (2009).

18. Huang, R. Y. M., Rhim, J. W. Modification of poly(vinyl alcohol) using maleic acid and its application to the separation of acetic acid-water mixtures by the pervaporation technique. Polymer Inter., 30, 129-135 (1993).

19. Gimenez, V., Mantecon, A., Cadiz, V. Crosslinking of poly(vinyl alcohol) using dianhydrides as hardeners. J. Appl. Polymer Sci., 59, 425-431 (1996).

20. Meyyappan, M. Carbon Nanotubes: Science and Applications. CRC Press, Boca Raton, Fla. (2004).

21. Bagchi, A. and Nomura, S. On the effective thermal conductivity of carbon nanotube reinforced polymer composites. Comp. Sci. Technol., 66, 1703-1712 (2006).

22. Valentini, L., Armentano, I., Santini, P., Kenny, J. M., Lozzi, L. and Santucci, S. Electrical transport properties of conjugated polymer onto self-assembled aligned carbon nanotubes. Diamond Rel. Mater., 12, 1524-1531 (2003).

23. Coleman, J. N., Khan, U. and Gunko, Y. K. Mechanical reinforcement of polymers using carbon nanotubes. Adv. Mater., 18, 689-706 (2006).

24. Yah, C. S., Simate, G. S., Moothi, K., Maphutha, K. S. and Iyuke, S. E. Synthesis of large carbon nanotubes from ferrocene: the chemical vapour deposition technique. Trends Appl. Sci., 6, 1270-1279 (2011).

25. Iyuke, S. E., Mamvura, T. A., Liu, K., Sibanda, V., Meyyappan, M. and Varadan, V. K. Process synthesis and optimization for the production of carbon nanostructures. Nanotechnology, 20, 375602 (2009).

26. Coleman, J. N., Khan, U., Blau, W. J. and Gunko, Y. K. Small but strong: A review of the mechanical properties of carbon nanotube-polymer composites. Carbon, 44, 1624-1652 (2006).

27. Qian, D., Dickey, E. C., Andrews, R. and Rantell, T. Load transfer and deformation mechanisms in carbon nanotube-polystyrene composites. Appl. Phys. Lett., 76, 2868-2870 (2000).

28. Kearns, J. C. and Shambaugh, R. L. Polypropylene fibers reinforced with carbon nanotubes. J. Appl. Polymer Sci., 86, 2079-2084 (2002).

29. Gorga, R. E. and Cohen, R. E. Toughness enhancements in PMMA by addition of oriented MWCNTs. J. Polymer Sci., 42, 2690-2702 (2004).

30. Fomes, T. D., Baur, J. W., Sabba, Y. and Thomas, E. L. Morphology and properties of melt-spun polycarbonate fibers containing single- and multi-wall carbon nanotubes. Polymer, 47, 1704-1714 (2006).

31. Cadek, M., Coleman, J. N., Barron, V., Hedicke, K. and Blau, W. J. Morphological and mechanical properties of CNT-reinforced semicrystalline and amorphous polymer composites. Appl. Phys. Lett., 81, 5123-5125 (2002).

32. Chae, H. G., Sreekumar, T. V., Uchida, T. and Kumar, S. A comparison of reinforcement efficiency of various types of carbon nanotubes in polyacrylonitrile fiber. Polymer, 46, 10925-10935 (2005).

33. Ogasawara, T., Ishida, Y., Ishikawa, T. and Yokota, R. Characterization of MWNT/phentlethynyl terminated polyimide composites. Composites A, 35, 67-74 (2004).

34. Xiong, J., Zheng, Z., Qin, X., Li, M., Li, H. and Wang, X. Thermal and mechanical properties of a polyutherane/MWCNT composite. Carbon, 44, 2701-2707 (2006).

35. Ebrahimi, M., Ashaghi, K. S., Engel, L., Willershausen, D., Mund, P., Bolduan, P., Czermak, P. Characterization and application of different ceramic membranes for the oil-field produced water treatment. Desalination, 245, 533-540 (2009).

36. Kong, Y., Shi, D., Yu, H., Wang, Y., Yang, J., Zhang, Y. Separation performance of polyimide nanofiltration membranes for solvent recovery from dewaxed lube oil filtrates. Desalination, 191, 254-261 (2006).

37. Chunjin, W., Aimin, L , Lei, L., Long, Z., Hui, W., Xuehua, Q., et al. Treatment of oily water by a poly(vinyl alcohol) ultrafiltration membrane. Desalination, 225, 312-321 (2008).

38. Srijaroonrat, P., Julien, E. and Aurelle, Y. Unstable secondary oil/water emulsion treatment using ultrafiltration: fouling control by backflushing. J. Membrane Sci., 159, 11-20 (1999).

39. Gohil, J. M., Bhattacharya, A., Ray, J. Studies on the cross-linking of poly(vinyl alcohol). J. Polymer Res., 13, 161-169 (2006).

40. Gebben, B., Van den-Berg, H. W. A., Bargeman, D., Smolders, C. A. Intramolecular crosslinking of poly(vinyl alcohol). Polymer, 26, 1737-1740 (1985).

1. A device for use in fluid purification, the device comprising:
a hydrophobic polymer layer;
a multitude of carbon nanostructures dispersed within the hydrophobic polymer layer; and
a hydrophilic substance at least partially coating the hydrophobic layer.

2. The device according to claim 1, wherein the device is a membrane.

3. The device according to claim 1, wherein the hydrophilic layer further comprise a cross-linker substance.

4. The device according to claim 3, wherein the cross-linker substance comprises at least one substance selected from the group consisting of: period acids, metal salts, any one of the Hofmeister series of salts, aldehydes, dialdehydes, hydrogen together with hydroxyl radicals and carboxylic acids.

5. The device according to claim 4, wherein the cross-linker substance is maleic acid.

6. The device according to claim 1, wherein the hydrophobic polymer layer comprises at least one compound selected from the group consisting of natural or synthetic hydrophobic polymers.

7. The device according to claim 6, wherein the hydrophobic polymer is polysulfone.

8. The device according to claim 1, wherein the carbon nanostructure is at least one of the group consisting of: a carbon nanotube, a carbon nanofibre, a helical carbon nanotube, and a carbon nanoball.

9. The device according to claim 8, wherein the carbon nanostructure is a multi-walled carbon nanotube.

10. The device according to claim 1, wherein the hydrophilic substance comprises at least one compound selected from the group consisting of: natural or synthetic hydrophilic polymers.

11. The device according to claim 10, wherein the hydrophilic polymer is polyvinyl alcohol (PVA).

12. The device according to claim 1, wherein the hydrophobic polymer layer is a basal layer and has on top of an upper surface thereof a top layer comprising the hydrophilic substance so as to be layered like a sandwich having the top layer superposingly located over the basal layer.

13. The device according to claim 1, wherein the hydrophobic polymer layer comprises between about 0.1 to about 7.5% of carbon nanostructures, which carbon nanostructures are dispersed within the hydrophobic polymer layer.

14. Use of the device according to claim 1, in the purification of a water sample, the water sample comprising at least water and oil, such that in use, water flows through the device and oil is hindered from flowing through the device.

15. The device according to claim 1, wherein the hydrophobic layer is an inner core and has coated there over an outer shell comprising the hydrophilic substance.

16. A membrane for use in fluid purification, the membrane comprising:
a porous basal layer in the form of polysulfone (PSF);
a multitude of multi-walled carbon nanotubes (CNTs) dispersed within the basal layer; and
a top layer in the form of polyvinyl alcohol (PVA).

17. The membrane according to claim 16, wherein the top layer of polyvinyl alcohol (PVA) further comprises a cross-linker substance in the form of maleic acid (MA), in use, cross-linking the polyvinyl alcohol (PVA).

18. A method for manufacturing the device for use in fluid purification according claim 1, the method comprising the following steps:
(a) adding a hydrophobic polymer and carbon nanostructures to an organic solvent under constant stirring to produce Solution 1;
(b) casting Solution 1 onto a surface and allowing the cast Solution 1 to stand for a first period of time;
(c) immersing the cast Solution 1 in water for a second period of time to form a solid porous basal layer;
(d) pouring a hydrophilic substance over the porous basal layer to form a bilayered membrane; and
(e) placing the bilayered membrane into a heated oven for a third period of time.

19. The method according to claim 18, further comprising an additional step, Step (f) prior to executing Step (e), Step (f) comprising pouring a cross-linker substance over the hydrophilic substance to facilitate cross-linking of the hydrophilic substance.

20. The method according to claim 19, wherein the cross-linker is maleic acid.

21. A method for manufacturing the membrane for use in fluid purification according to claim 16, the method comprising the following steps:
(a) adding polysulfone (PSF) and multi-walled carbon nanotubes to dimethylformamide (DMF) under constant stirring to produce Solution 1;
(b) casting Solution 1 onto a surface and allowing the cast Solution to stand for a first period of time;
(c) immersing the cast Solution in water for a second period of time to form a solid porous basal polysulfone (PSF)-carbon nanotube (CNT) layer;
(d) pouring polyvinyl alcohol (PVA) solution over the porous basal polysulfone (PSF)-carbon nanotube (CNT) layer to form a bilayered membrane; and
(e) placing the bilayered membrane into a heated oven for a third period of time.

22. The method according to claim 21, further comprising an additional step, Step (f) prior to Step (e), Step (f) comprising pouring a maleic acid solution over the polyvinyl alcohol (PVA) to facilitate cross-linking of the polyvinyl alcohol (PVA).
